(19) United States
(12) Patent Application Publication
(10) Pub. No.: US 2019/0256361 A1
(43) Pub. Date: Aug. 22, 2019

(54) METHOD FOR PRODUCING OLIGOSILANE

(71) Applicant: SHOWA DENKO K.K., Tokyo (JP)

(72) Inventors: Kiyoshi NOMURA, Tokyo (JP); Hiroshi UCHIDA, Tokyo (JP); Yoshimitsu ISHIHARA, Tsukuba-shi (JP); Yumiko NAKAJIMA, Tsukuba-shi (JP); Shigeru SHIMADA, Tsukuba-shi (JP); Kazuhiko SATO, Tsukuba-shi (JP)

(73) Assignee: SHOWA DENKO K.K., Tokyo (JP)

(21) Appl. No.: 16/308,323

(22) PCT Filed: Jun. 6, 2017
(86) PCT No.: PCT/JP2017/021030

§ 371 Date: Dec. 7, 2018

(30) Foreign Application Priority Data
Jun. 10, 2016 (JP) 2016-116396

(51) Int. Cl. C01B 33/04; B01J 29/48; B01J 29/46; B01D 53/22; B01J 35/10

(52) U.S. Cl. CPC C01B 33/04; B01J 29/48; B01J 35/1057; B01D 53/229; B01J 29/46

(57) ABSTRACT

An object of the present invention is to provide an oligosilane production method with which a target oligosilane can be selectively produced. Oligosilanes can be efficiently produced at an improved selectivity for a target oligosilane by using, as a raw material, not only monosilane but also an oligosilane with a smaller number of silicon atoms than the target oligosilane or conversely an oligosilane with a larger number of silicon atoms than the target oligosilane.

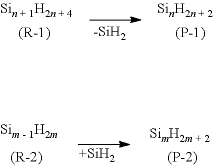

### TECHNICAL FIELD

The present invention relates to a method for producing an oligosilane.

### BACKGROUND ART

Hexahydrodisilane (Si₂H₆, hereinafter may be abbreviated as “disilane”), which is a typical oligosilane, is a useful compound as, for example, precursors for the formation of silicon films, whereas octahydrotrisilane (Si₃H₈, hereinafter may be abbreviated as “trisilane”), which is hardly in demand at present, is expected to be utilized in future as precursors for the formation of silicon films instead of disilane, since octahydrotrisilane has a low decomposition temperature.

Conventionally, the following methods for producing oligosilanes, for example, have been reported: the acid decomposition of magnesium silicide (refer to Non-Patent Document 1), the reduction of hexachlorodisilane (refer to Non-Patent Document 2), electric discharge in tetrahydrosilane (SiH₄, hereinafter may be abbreviated as “silane” or “monosilane”) (refer to Patent Document 1), the thermal decomposition of silane (refer to Patent Documents 2 to 4), and the dehydrogenative coupling of silane using a catalyst (refer to Patent Documents 5 to 10).

### PRIOR ART DOCUMENT

### Patent Document

Patent Document 1: U.S. Pat. No. 5,478,453
Patent Document 2: Japanese Patent No. 4855462
Patent Document 3: Japanese Patent Application Laid-open No. H11-260729
Patent Document 4: Japanese Patent Application Laid-open No. H03-183613
Patent Document 5: Japanese Patent Application Laid-open No. H01-198631
Patent Document 6: Japanese Patent Application Laid-open No. H02-184513
Patent Document 7: Japanese Patent Application Laid-open No. H05-032785
Patent Document 8: Japanese Translation of PCT Application No. 2013-506541
Patent Document 9: WO2015/060189
Patent Document 10: WO2015/090996

### Non-Patent Document

Non-Patent Document 1: Hydrogen Compounds of Silicon. I. The Preparation of Mono- and Disilane, WARREN C. JOHNSON and SAMPSON ISENBERG, J. Am. Chem. Soc., 1935, 57, 1349.
Non-Patent Document 2: The Preparation and Some Properties of Hydrides of Elements of the Fourth Group of the Periodic System and of their Organic Derivatives, A. E. FINHOLT, A. C. BOND Jr., K. E. WILZBACH and H. I. SCHLESINGER. J. Am. Chem. Soc., 1947, 69, 2692.

### SUMMARY OF INVENTION

### Problem to be Solved by Invention

With regard to the aforementioned methods, the acid decomposition of magnesium silicide, the reduction of hexachlorodisilane, and electric discharge in monosilane, for example, generally tend to readily impose high production costs. In addition, although the thermal decomposition of silane and the dehydrogenative coupling of silane using a catalyst, for example, serve the purpose of selectively synthesizing a particular oligosilane, e.g., disilane, the ratio between disilane and trisilane is uniquely determined by the reaction conditions when monosilane is used as a raw material. Consequently, if disilane only is targeted, trisilane produced as a by-product is unavoidably discarded, and if a large ratio of trisilane is desired, the obtained disilane needs to be further reacted separately.

An object of the present invention is to provide an oligosilane production method with which a target oligosilane can be selectively produced.

### Solution to Problem

As a result of intensive and extensive investigations directed to solving the problem indicated above, the present inventors have found out that oligosilanes can be efficiently produced at an improved selectivity for a target oligosilane by using, as a raw material, not only monosilane but also an oligosilane with a smaller number of silicon atoms than the target oligosilane or conversely an oligosilane with a larger number of silicon atoms than the target oligosilane. The present invention was achieved based on this finding.

Thus, the present invention is as follows.

<1> A method for producing an oligosilane, comprising a step 1-1 of producing an oligosilane represented by the following formula (P-1) using tetrahydrosilane (SiH₄) as a raw material:

SiₙH²ⁿ⁺² (P-1)

where n represents an integer of from 2 to 5,

the step 1-1 comprising producing the oligosilane represented by formula (P-1) from an oligosilane represented by the following formula (R-1) using the oligosilane represented by formula (R-1) as a raw material together with tetrahydrosilane (SiH₄):

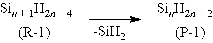

where n represents an integer of from 2 to 5.
<2> The method for producing an oligosilane according to <1>, wherein the oligosilane represented by formula (R-1) is octahydrotrisilane (Si₃H₈), and the oligosilane represented by formula (P-1) is hexahydrodisilane (Si₂H₆).
<3> A method for producing an oligosilane, comprising a step 1-2 of producing an oligosilane represented by the following formula (P-2) using tetrahydrosilane (SiH₄) as a raw material:

SiₘH₂ₘ₊₂ (P-2)

where m represents an integer of from 3 to 5,

the step 1-2 comprising producing the oligosilane represented by formula (P-2) from an oligosilane represented by the following formula (R-2) using the oligosilane represented by formula (R-2) as a raw material together with tetrahydrosilane (SiH₄):

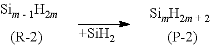

where m represents an integer of from 3 to 5.
<4> The method for producing an oligosilane according to <3>, wherein the oligosilane represented by formula (R-2) is hexahydrodisilane (Si₂H₆), and the oligosilane represented by formula (P-2) is octahydrotrisilane (Si₃H₈).
<5> The method for producing an oligosilane according to any one of <1> to <4>, wherein the step 1-1 or 1-2 is carried out in the presence of hydrogen gas.
<6> The oligosilane production method according to any one of <1> to <5>, wherein the step 1-1 or 1-2 is carried out in the presence of a catalyst containing a transition element.
<7> The method for producing an oligosilane according to <6>, wherein the transition element contained in the catalyst is at least one transition element selected from the group consisting of group 5 transition elements, group 6 transition elements, group 7 transition elements, group 8 transition elements, group 9 transition elements, and group 10 transition elements.
<8> The method for producing an oligosilane according to <6> or <7>, wherein the catalyst is a heterogeneous catalyst containing a support.
<9> The method for producing an oligosilane according to <8>, wherein the support is at least one selected from the group consisting of silica, alumina, and zeolites.
<10> The method for producing an oligosilane according to <9>, wherein the zeolite has pores with a minor diameter of at least 0.43 nm and a major diameter of not more than 0.69 nm.
<11> The method for producing an oligosilane according to any one of <1> to <10>, further comprising a second step comprising subjecting a mixture obtained through the step 1-1 or 1-2 to at least one treatment selected from the following treatments (i) to (iii) to obtain a liquid containing the oligosilane represented by formula (P-1) or (P-2):
(i) compressing and/or cooling the mixture;
(ii) bringing the mixture in contact with an absorbing liquid; and
(iii) bringing the mixture in contact with an adsorbent, followed by desorbing and compressing and/or cooling.
<12> The method for producing an oligosilane according to <11>, wherein in the treatment (i), a cooling temperature is from −200° C. to −20° C.
<13> The method for producing an oligosilane according to <11>, wherein in the treatment (ii), the absorbing liquid is at least one liquid selected from the group consisting of hydrogenated silicon compounds, saturated hydrocarbons, and aromatic hydrocarbons.
<14> The method for producing an oligosilane according to <11>, wherein in the treatment (iii), the adsorbent is at least one solid adsorbent selected from the group consisting of natural zeolites, synthetic zeolites, alumina gel, silica gel, and activated carbon.
<15> The method for producing an oligosilane according to any one of <11> to <14>, further comprising a third step comprising separating the liquid obtained through the second step and containing the oligosilane represented by formula (P-1) or (P-2), from gas being a gaseous phase.
<16> The method for producing an oligosilane according to <15>, further comprising a fourth step comprising separating hydrogen gas from the gas being a gaseous phase obtained through the third step using a hydrogen separating membrane.
<17> The method for producing an oligosilane according to any one of <1> to <16>, wherein the method is a one-pass method where the step 1-1 or 1-2 is carried out only once.
<18> The method for producing an oligosilane according to <16>, wherein the method is a recycling method where at least part of tetrahydrosilane (SiH₄) and the oligosilane represented by formula (R-1) unreacted in the step 1-1 is resupplied and reused as a raw material.
<19> The method for producing an oligosilane according to <16>, wherein the method is a recycling method where at least part of tetrahydrosilane (SiH₄) and the oligosilane represented by formula (R-2) unreacted in the step 1-2 is resupplied and reused as a raw material.

### Effect of the Invention

According to the present invention, oligosilanes such as disilane and trisilane are efficiently produced in accordance with the market conditions such as demand.

### BRIEF DESCRIPTION OF DRAWINGS

FIG. 1 is a schematic diagram of an apparatus that can be used in the oligosilane production method of the present invention (continuous one-pass method).

FIG. 2 is a schematic diagram of an apparatus that can be used in the oligosilane production method of the present invention (continuous recycling method).

FIG. 3 is a schematic diagram of reactors that can be used in the oligosilane production method of the present invention ((a): a batch tank reactor, (b): a continuous tank reactor (fluidized bed), (c): a continuous tubular reactor (fixed bed)).

FIG. 4 is a schematic diagram of an apparatus that was used in the oligosilane production method of the present invention.

### DESCRIPTION OF EMBODIMENTS

Although specific examples will be described in the description of the details of the oligosilane production method of the present invention, the present invention is not limited to the following description and can be appropriately modified in the execution insofar as there is no departure from the essential features of the present invention.

The oligosilane production method that is one aspect of the present invention (hereinafter may be abbreviated as “production method 1”) includes a step of producing an oligosilane represented by the following formula (P-1) by using tetrahydrosilane (SiH₄) as a raw material, and is characterized in that the step (hereinafter may be abbreviated as “Step 1-1”) includes producing the oligosilane represented by formula (P-1) from an oligosilane represented by the following formula (R-1) using the oligosilane represented by formula (R-1) as a raw material together with tetrahydrosilane (SiH₄):

SiₙH₂ₙ₊₂ (P-1)

where n represents an integer of from 2 to 5,

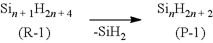

where n represents an integer of from 2 to 5.

The oligosilane production method that is another aspect of the present invention (hereinafter may be abbreviated as “production method 2”) includes a step of producing an oligosilane represented by the following formula (P-2) by likewise using tetrahydrosilane (SiH₄) as a raw material, and is characterized in that the step (hereinafter may be abbreviated as “Step 1-2”) includes producing the oligosilane represented by formula (P-2) from an oligosilane represented by the following formula (R-2) by using the oligosilane represented by formula (R-2) as a raw material together with tetrahydrosilane (SiH₄):

SiₘH₂ₘ₊₂ (P-2)

where m represents an integer of from 3 to 5,

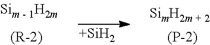

where m represents an integer of from 3 to 5.

The present inventors have found out that oligosilanes can be efficiently produced at an improved selectivity for a target oligosilane by using, as a raw material, not only tetrahydrosilane (SiH₄) [monosilane] but also an oligosilane with a smaller number of silicon atoms than the target oligosilane or conversely an oligosilane with a larger number of silicon atoms than the target oligosilane.

For example, as represented by the following formulae, trisilane is known to decompose into silylene (SiH₂) and disilane when heated, and silylene can react with monosilane to convert to disilane in the presence of excess monosilane. In other words, one molecule of trisilane can be converted to two molecules of disilane with the addition of monosilane as a raw material, and as a result, selectivity for disilane in the reaction can be improved.

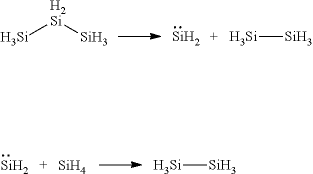

Further, for example, in continuous production of disilane, by recovering trisilane produced as a by-product and supplying the recovered trisilane as a raw material together with monosilane, an improved selectivity for disilane and reuse of trisilane are achieved. Thus, a very efficient production method is provided.

Still further, although trisilane is hardly in demand at present, if demand for trisilane grows in the future, disilane produced in the reaction may be recovered and used as a raw material together with monosilane. Disilane is also known to decompose into silylene and monosilane, and when a large amount of disilane is present, silylene generated from monosilane and disilane, reacts with disilane to produce trisilane; therefore, selectivity for trisilane can be relatively increased.

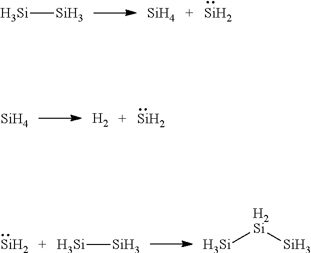

It is noted that “use as a raw material” means active use as a raw material, and more specifically means introduction into a reactor prior to a reaction when a batch reactor is used and intermittent or continuous supply to a reactor when a continuous reactor is used.

The production methods 1 and 2 should respectively include Step 1-1 and Step 1-2, but the specific aspects of the entire “oligosilane production method” from Step 1-1 or 1-2 to the isolation of the oligosilane represented by formula (P-1) or (P-2) are not particularly limited and may be classified as either (A) or (B) below ((B) may be classified into (B-1) and (B-2)).

(A) Batch method: a method in which introduction of raw materials into a reactor, reaction, recovery of reacted products are carried out independently from each other in Step 1-1 or 1-2.
(B) Continuous method: a method in which introduction of raw materials into a reactor, reaction, recovery of reacted products are continuously carried out in Step 1-1 or 1-2.

(B-1) One-pass method: a method in which Step 1-1 or 1-2 is carried out as a separate step by not continuously performing recovery and reuse of tetrahydrosilane (SiH₄) and the like from a mixture obtained through Step 1-1 or 1-2, unlike in (B-2).

(B-2) Recycling method: a method in which Step 1-1 or 1-2 is carried out continuously in such a manner that all or part of tetrahydrosilane (SiH₄) and oligosilanes and the like usable for a reaction is recovered from a mixture obtained through Step 1-1 or 1-2 while the remaining reaction gas is, without being isolated and in a gaseous as-is state, reintroduced into a reactor.

“Tetrahydrosilane (SiH₄) and the like” means that an oligosilane(s) other than tetrahydrosilane (SiH₄) is (are) included in a small amount.

“Step 1-1”, “Step 1-2”, and other steps are described in detail in the following.

(Step 1-1 ⋅ Step 1-2)

Step 1-1 is characterized in using an oligosilane represented by formula (R-1) as a raw material together with tetrahydrosilane (SiH₄), and it is preferred to use octahydrotrisilane (Si₃H₈) as the oligosilane represented by formula (R-1).

In Step 1-1, the amount of an oligosilane represented by formula (R-1) used is generally at least 0.001 times the amount of tetrahydrosilane (SiH₄) used on molar basis, preferably at least 0.003 times, and more preferably at least 0.005 times and is generally not more than 0.5 times, preferably not more than 0.3 times, and more preferably not more than 0.2 times. When the amount of the oligosilane used is not more than 0.5 times the amount of tetrahydrosilane (SiH₄) used, the by-production of an oligosilane with a larger number of silicon atoms than a target oligosilane, which is caused by a reaction of silylene generated from the oligosilane and monosilane with the oligosilane, is at a low level that causes no problem.

Step 1-2 is characterized in using an oligosilane represented by formula (R-2) as a raw material together with tetrahydrosilane (SiH₄), and it is preferred to use hexahydrodisilane (Si₂Hs) as the oligosilane represented by formula (R-2).

In Step 1-2, the amount of an oligosilane represented by formula (R-2) used is generally at least 0.005 times the amount of tetrahydrosilane (SiH₄) used on molar basis, preferably at least 0.05 times, and more preferably at least 0.1 times and is generally not more than 2 times, preferably not more than 1.5 times, and more preferably not more than 1 times. Here, when the amount of the oligosilane used is at least 0.005 times the amount of tetrahydrosilane (SiH₄) used, increased efficiency in the reaction between generated silylene and the oligosilane is achieved, which has an effect of increasing the number of silicon atoms. In addition, when it is not more than 2 times, the byproduction of an oligosilane with a larger number of silicon atoms than a target oligosilane, which is caused by a reaction between silylene generated from the oligosilane and monosilane with the oligosilane, is at a low level that causes no problem.

The reaction temperature in Steps 1-1 and 1-2 in the absence of a catalyst is at least 300° C. and not more than 550° C., and more preferably at least 400° C. and not more than 500° C., depending on the operation pressure and the residence time. When a catalyst is used, the reaction temperature is generally at least 50° C., preferably at least 100° C. and is generally not more than 400° C., preferably not more than 350° C., and more preferably not more than 300° C., depending on the operation pressure. If within the indicated ranges, oligosilane production can be carried out more efficiently. In any case, it is preferable to suppress the conversion of silane and oligosilanes used as raw materials to not more than 30% and more preferably not more than 20% by devising the residence time. It is possible but not preferable to make the conversion higher than 30%, because a higher conversion results in sequential production of an oligosilane with a higher molecular weight, and if the conversion is made too high, a solid oligosilane could be produced, which is unpreferable. The residence time is from 1 second to 1 hour, more preferably from 5 seconds to 30 minutes, and even more preferably from 10 seconds to 10 minutes, depending on the reaction temperature and the presence or absence of a catalyst.

Steps 1-1 and 1-2 are preferably carried out in the presence of a catalyst that contains a transition element (hereinafter may be abbreviated as “catalyst”) from the stand point of efficiency of oligosilane production. The specific species of the transition element is not particularly limited, and examples thereof include group 3 transition elements, group 4 transition elements, group 5 transition elements, group 6 transition elements, group 7 transition elements, group 8 transition elements, group 9 transition elements, group 10 transition elements, and group 11 transition elements.

Examples of group 3 transition elements include scandium (Sc), yttrium (Y), lanthanoid (La), and samarium (Sm).

Examples of group 4 transition elements include titanium (Ti), zirconium (Zr), and hafnium (Hf).

Examples of group 5 transition elements include vanadium (V), niobium (Nb), and tantalum (Ta).

Examples of group 6 transition elements include chromium (Cr), molybdenum (Mo), and tungsten (W).

Examples of group 7 transition elements include manganese (Mn), technetium (Tc), and rhenium (Re).

Examples of group 8 transition elements include iron (Fe), ruthenium (Ru), and osmium (Os).

Examples of group 9 transition elements include cobalt (Co), rhodium (Rh), and iridium (Ir).

Examples of group 10 transition elements include nickel (Ni), palladium (Pd), and platinum (Pt).

Examples of group 11 transition elements include copper (Cu), silver (Ag), and gold (Au).

Among these transition elements, group 5 transition elements, group 6 transition elements, group 7 transition elements, group 8 transition elements, group 9 transition elements, and group 10 transition elements are preferred, among which tungsten (W), vanadium (V), molybdenum (Mo), cobalt (Co), nickel (Ni), palladium (Pd), and platinum (Pt) are more preferred, and cobalt (Co), tungsten (W), and molybdenum (Mo) are even more preferred.

As long as the catalyst contains a transition element, it may be a heterogeneous catalyst or a homogeneous catalyst; however, heterogeneous catalysts are preferred, and support-containing heterogeneous catalysts are particularly preferred.

The form and composition of the transition element in the catalyst are also not particularly limited, and, for example, in the case of a heterogeneous catalyst, the form may be that of a metal (a metal simple substance, an alloy) optionally having an oxidized surface or may be that of a metal oxide (a single metal oxide, a composite metal oxide). When the catalyst is a support-containing heterogeneous catalyst, for example, the metal or metal oxide may be supported at the outer surface and/or within the pores of the support, or the transition element may be introduced into the support framework by ion exchange or composite formation.

On the other hand, examples of the homogeneous catalyst include organometal complexes in which the central metal is a transition element.

Examples of the metal optionally having an oxidized surface include scandium, yttrium, lanthanoid, samarium, titanium, zirconium, hafnium, vanadium, niobium, tantalum, chromium, molybdenum, tungsten, manganese, technetium, rhenium, iron, ruthenium, osmium, cobalt, rhodium, iridium, nickel, palladium, platinum, copper, silver, and gold.

Examples of the metal oxide include scandium oxide, yttrium oxide, lanthanoid oxide, samarium oxide, titanium oxide, zirconium oxide, hafnium oxide, vanadium oxide, niobium oxide, tantalum oxide, chromium oxide, molybdenum oxide, tungsten oxide, manganese oxide, technetium oxide, rhenium oxide, iron oxide, ruthenium oxide, osmium oxide, cobalt oxide, rhodium oxide, iridium oxide, nickel oxide, palladium oxide, platinum oxide, copper oxide, silver oxide, and their composite oxides.

The specific species of the support is not particularly limited when the catalyst is a support-containing heterogeneous catalyst, and examples thereof include silica, alumina, zeolites, active carbon, and aluminum phosphate. Among these, zeolites are preferred, and a zeolite having pores with a minor diameter of at least 0.43 nm and a major diameter of not more than 0.69 nm is particularly preferred. The pore space in the zeolite is considered to act as a reaction field for dehydrogenative coupling, and a pore size of “a minor diameter of at least 0.43 nm and a major diameter of not more than 0.69 nm” is considered to be optimal for suppressing excessive polymerization and bringing about an improved selectivity for an oligosilane.

It is noted that “a zeolite having pores with a minor diameter of at least 0.43 nm and a major diameter of not more than 0.69 nm” does not mean only zeolites that actually have “pores with a minor diameter of at least 0.43 nm and a major diameter of not more than 0.69 nm”, but also includes zeolites for which the pore “minor diameter” and “major diameter” as theoretically calculated from the crystalline structure respectively satisf, the aforementioned conditions. For the pore “minor diameter” and “major diameter”, reference can be made to “ATLAS OF ZEOLITE FRAMEWORK TYPES, Ch. Baerlocher, L. B. McCusker and D. H. Olson, Sixth Revised Edition 2007, published on behalf of the structure Commission of the international Zeolite Association”.

The minor diameter for the zeolite is at least 0.43 nm and is preferably at least 0.45 nm and is particularly preferably at least 0.47 nm.

The major diameter for the zeolite is not more than 0.69 nm and is preferably not more than 0.65 nm and is particularly preferably not more than 0.60 nm.

When the pore diameter of the zeolite is constant because, for example, the cross-sectional structure of the pore is circular, the pore diameter is then regarded as “at least 0.43 nm and not more than 0.69 nm”.

When the zeolite has a plurality of pore diameters, then the pore diameter of at least one type of pore should be “at least 0.43 nm and not more than 0.69 nm”.

The specific zeolite is preferably a zeolite having a framework type code as provided in the database of the International Zeolite Association corresponding to the following: AFR, AFY, ATO, BEA, BOG, BPH, CAN, CON, DFO, EON, EZT, GON, IMF, ISV, ITH, IWR, IWV, IWW, MEI, MEL, MFI, OBW, MOZ, MSE, MTT, MTW, NES, OFF, OSI, PON, SFF, SFG, STI, STF, TER, TON, TUN, USI, and VET.

Zeolites with framework type codes corresponding to the following are more preferred: ATO, BEA, BOG, CAN, IMF. ITH, IWR. IWW, MEL, MFI, OBW, MSE, MTW, NES, OSI, PON, SFF, SFG, STF, STI, TER, TON, TUN, and VET.

Zeolites with framework type codes corresponding to BEA, MFI, and TON are particularly preferred.

Examples of zeolites with a framework type code corresponding to BEA include Beta (beta), [B—Si—O]-BEA, [Ga—Si—O]-BEA, [Ti—Si—O]-BEA, Al-rich beta, CIT-6, Tschernichite, and pure silica beta.

Examples of zeolites with a framework type code corresponding to MFI include ZSM-5, [As—Si—O]-MFI, [Fe—Si—O]-MFI, [Ga—Si—O]-MFI, AMS-1B, AZ−1. Bor-C, Boralite C, Encilite, FZ-1, LZ-105, Monoclinic H-ZSM-5, Mutinaite, NU-4, NU-5, Silicalite. TS-1, TSZ, TSZ-III, TZ-01, USC-4, USI-108, ZBH, ZKQ-1B, ZMQ-TB, and organic-free ZSM-5.

Examples of zeolites with a framework type code corresponding to TON include Theta-1, ISI-1, KZ-2, NU-10, and ZSM-22.

Zeolites ZSM-5, beta, and ZSM-22 are particularly preferred.

The silica/alumina ratio (mol/mol ratio) is preferably from 5 to 10,000, more preferably from 10 to 2,000, and particularly preferably from 20 to 1,000.

When the catalyst is a heterogeneous catalyst, the transition element content (overall content) in the catalyst with reference to the total mass of the entire catalyst (when the catalyst contains a support, the mass of the support is also included) is generally at least 0.01 mass %, preferably at least 0.1 mass %, and more preferably at least 0.5 mass % and is generally not more than 50 mass %, preferably not more than 20 mass %, and more preferably not more than 10 mass %. If within the indicated ranges, oligosilane production can be carried out more efficiently.

When the catalyst is a heterogeneous catalyst, the catalyst may contain at least one main group element (hereinafter may be abbreviated as “Periodic Table group 1 main group element or the like”) selected from the group consisting of Periodic Table group 1 main group elements and group 2 main group elements. The form and composition of Periodic Table group 1 main group element or the like in the catalyst is not particularly limited, and, for example, the form may be that of a metal oxide (a single metal oxide, a composite metal oxide). When the catalyst is a support-containing heterogeneous catalyst, for example, the metal oxide may be supported at the outer surface and/or within the pores of the support, or the Periodic Table group 1 main group element or the like may be introduced into the support framework by ion exchange or composite formation. The incorporation of such a main group element restrains the initial silane conversion to inhibit excessive consumption, and in combination with this can raise the initial disilane selectivity. In addition, the catalyst life can also be extended by restraining the initial silane conversion.

Examples of group 1 main group elements include lithium (Li), sodium (Na), potassium (K), rubidium (Rb), cesium (Cs), and francium (Fr).

Examples of group 2 main group elements include beryllium (Be), magnesium (Mg), calcium (Ca), strontium (Sr), barium (Ba), and radium (Ra).

Among the preceding, the incorporation of sodium (Na), potassium (K), rubidium (Rb), cesium (Cs), francium (Fr), calcium (Ca), strontium (Sr), and barium (Ba) is preferred.

Impregnation and ion-exchange are examples of methods for incorporating the Periodic Table group 1 main group element or the like in the catalyst when the catalyst is a support-containing heterogeneous catalyst. Impregnation is a method in which the support is brought into contact with a solution in which a Periodic Table group 1 main group element or the like is dissolved, and the Periodic Table group 1 main group element or the like is thereby adsorbed to the surface of the support. Ion-exchange is a method in which a support such as a zeolite is brought into contact with a solution in which an ion of a Periodic Table group 1 main group element or the like is dissolved, thereby introducing the ion of the Periodic Table group 1 main group element or the like at an acid site on the support. Treatments such as drying and firing may be carried out after the execution of impregnation or ion-exchange.

When a Periodic Table group 1 main group element or the like is contained, its content (overall content) with respect to the total mass of the entire catalyst (when the catalyst contains a support, the mass of the support is also included) is generally at least 0.01 mass %, preferably at least 0.05 mass %, more preferably at least 0.1 mass %, even more preferably at least 0.5 mass %, particularly preferably at least 1.0 mass %, and most preferably at least 2.1 mass %, and is generally not more than 10 mass %, preferably not more than 5 mass/%, and more preferably not more than 4 mass %. If within the indicated ranges, oligosilane production can be carried out more efficiently.

The reactor, operating procedure, reaction conditions, and the like used in Steps 1-1 and 1-2 are not particularly limited and can be selected as appropriate according to the purpose. The reactor, operating procedure, and the like are described in the following using specific examples, but not limited to the examples described.

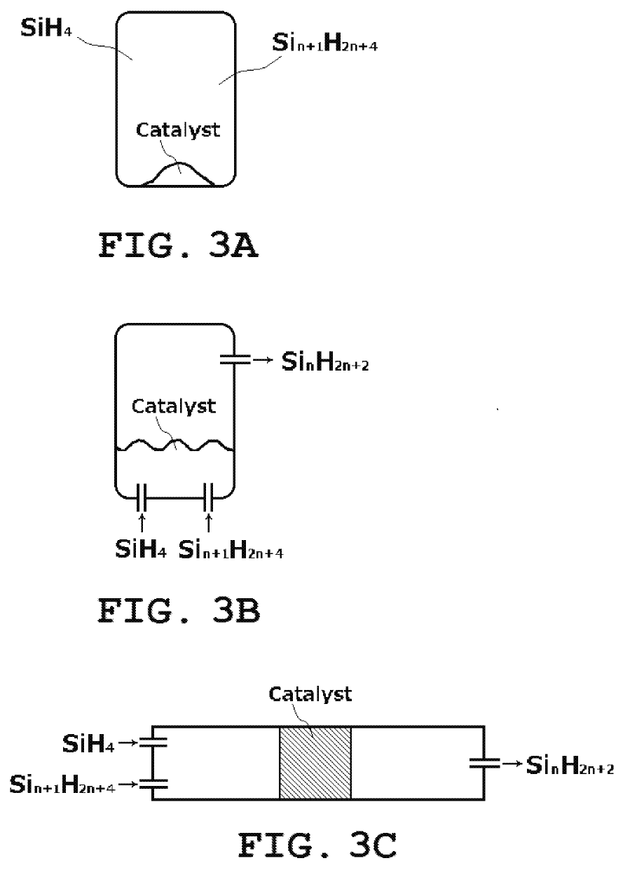

The reactor used in a batch method is exemplified by a tank reactor as shown in FIG. 3(a), and the reactor used in a continuous method is exemplified by a tank reactor (fluidized bed) as shown in FIG. 3(b) and a tubular reactor (fixed bed) as shown in FIG. 3(c).

The operating procedure in, for example, a batch method, is exemplified by the following method: the air in a reactor is removed using a vacuum pump or the like; subsequently, tetrahydrosilane (SiH₄), an oligosilane represented by formula (R-1) or (R-2), and the like are introduced and sealing is performed; and the reaction is started by raising the interior of the reactor to the reaction temperature. When a catalyst is used, the operating procedure for example includes placing a dried catalyst in the reactor before removing the air in the reactor.

On the other hand, in a continuous method, the operating procedure is exemplified by the following method: the air in the reactor is removed using a vacuum pump or the like; subsequently, tetrahydrosilane (SiH₄), an oligosilane represented by formula (R-1) or (R-2), and the like are caused to flow through; and the reaction is started by raising the interior of the reactor to the reaction temperature. When a catalyst is used, the operating procedure for example includes placing a dried catalyst in the reactor before removing the air in the reactor. The catalyst may be either a fixed-bed catalyst as shown in FIG. 3 (c) or a fluidized bed catalyst as shown in FIG. 3 (b), based on which an operation procedure may be employed as appropriate.

Compounds other than tetrahydrosilane (SiH₄), an oligosilane represented by formula (R-1) or (R-2), and the like may be introduced into or passed through the reactor. Examples of the compounds other than tetrahydrosilane (SiH₄), an oligosilane represented by formula (R-1) or (R-2), and the like include gases such as hydrogen gas, helium gas, nitrogen gas, and argon gas, and execution in the presence of hydrogen gas is particularly preferred.

The reaction pressure in Steps 1-1 and 1-2, considered as the absolute pressure, is generally at least 0.1 MPa, preferably at least 0.15 MPa. and more preferably at least 0.2 MPa and is generally not more than 1,000 MPa, preferably not more than 500 MPa, and more preferably not more than 100 MPa. The hydrosilane partial pressure is generally at least 0.0001 MPa, preferably at least 0.0005 MPa. and more preferably at least 0.001 MPa and is generally not more than 100 MPa, preferably not more than 50 MPa, and more preferably not more than 10 MPa. If within the indicated ranges, oligosilane production can be carried out more efficiently.

When Steps 1-1 and 1-2 are carried out in the presence of hydrogen gas, the partial pressure of the hydrogen gas with respect to the partial pressure of tetrahydrosilane and oligosilanes is from 0.05 to 5, preferably from 0.1 to 4, and more preferably from 0.02 to 2 (hydrogen gas/(tetrahydrosilane and oligosilanes)).

(Step 2)

The production methods 1 and 2 should respectively include Steps 1-1 and 1-2, but are not otherwise particularly limited, and for example, the methods may include a second step (hereinafter may be abbreviated as “Step 2”) which includes subjecting a mixture obtained through Step 1-1 or 1-2 to at least one treatment selected from the following treatments (i) to (iii) to obtain a liquid containing an oligosilane represented by formula (P−1) or (P-2) (hereinafter collectively referred to as “formula (P)”):

(i) compressing and/or cooling the mixture:
(ii) bringing the mixture in contact with an absorbing liquid; and
(iii) bringing the mixture in contact with an adsorbent, followed by desorbing and compressing and/or cooling.

The mixture obtained through Step 1-1 or 1-2 is considered to also include, other than hydrogen gas, tetrahydrosilane (SiH₄), and an oligosilane represented by formula (P), an oligosilane with a larger number of silicon atoms (the number of silicon atoms ≥6) than the oligosilane represented by formula (P). Step 2 changes the state of an oligosilane represented by formula (P) into liquid, thereby making the oligosilane easy to separate from components such as tetrahydrosilane and hydrogen gas which each have a low boiling point, a low solubility to the absorbing liquid, or a small adsorption amount to the adsorbent.

Although components to be in liquid states and components to be in gaseous states may be selected as appropriate depending on the conditions of treatments (i) to (iii), the following are preferably employed in a one-pass method and a recycling method.

### (One-Pass Method)

In a one-pass method, unless tetrahydrosilane as a raw material is collected, unit consumption deteriorates. The following is therefore desirable.

Liquid: tetrahydrosilane (SiH₄), hexahydrodisilane (Si₂H₆), octahydrotrisilane (SitHs), and an oligosilane with a larger number of silicon atoms than an oligosilane represented by formula (P).

Gas: hydrogen gas

### (Recycling Method)

When recycling, it is more efficient to use tetrahydrosilane, which is a raw material having a low boiling point, as it is rather than spending energy to collect tetrahydrosilane in a liquid state. The following is therefore desirable.

Liquid: hexahydrodisilane (Si₂H₆), octahydrotrisilane (Si₃H₈), and an oligosilane with a larger number of silicon atoms than an oligosilane represented by formula (P).

Gas: tetrahydrosilane (SiH₄) and hydrogen gas

“Treatment (i)”, “treatment (ii)”, and “treatment (iii)” and the like are described in detail in the following.

Treatment (i) is for compressing and/or cooling the mixture, and compressing conditions, cooling conditions, and the like should be selected as appropriate according to components to be in liquid states and components to be in gaseous states.

The cooling temperature when under normal pressure is generally at least −200° C. and not more than −20° C. and preferably at least −180° C. and not more than −50° C.

Treatment (i) may for example be carried out using a recovery apparatus employing publicly known compression cryogenic condensation.

Treatment (ii) is for bringing the mixture into contact with an absorbing liquid, and the absorbing liquid, the temperature of the absorbing liquid, and the like should be selected as appropriate according to components to be in liquid states and components to be in gaseous states.

Examples of the absorbing liquid for monosilane and oligosilanes include hydrogenated silicon compounds such as trisilane and tetrasilane, alkylsilanes such as hexamethyldisilane, saturated hydrocarbons such as hexane, heptane, and octane, and aromatic hydrocarbons such as toluene and xylene.

The operation temperature is at least −50° C. and not more than the boiling point of the solvent under the operation pressure, more preferably at least −20° C. and not more than a temperature lower than the boiling point of the solvent under the operation pressure by 10° C. When the temperature is made too low, the energy cost is very high, which makes direct condensation more advantageous than using the absorbing liquid. Further, when the temperature is high, efficient dissolution into the absorbing liquid cannot be achieved.

A method for bringing the mixture into contact with the absorbing liquid for example in a continuous method is exemplified by bringing the absorbing liquid into contact with the mixture in a countercurrent.

Treatment (iii) is for bringing the mixture in contact with an adsorbent, followed by desorbing and compressing and/or cooling. The absorbent, the heating temperature for desorption, the cooling temperature, and the like should be selected as appropriate according to components to be in liquid states and components to be in gaseous states.

Examples of the absorbent for monosilane and oligosilanes include zeolites (natural zeolites and synthetic zeolites), alumina gel, silica gel, and activated carbon. Among these, a zeolite having pores (molecular sieve) is preferred.

Desorption is for example carried out by heating, and the heating temperature is generally at least −10° C. and not more than 200° C. and preferably at least 20° C. and not more than 150° C.

The cooling temperature after desorption when under normal pressure is generally at least −50° C. and not more than 150° C. and preferably at least −15° C. and not more than 100° C. The operation temperature may be room temperature or higher under pressure.

Treatment (iii) may for example be carried out using an adsorption tower.

(Step 3)

The production methods 1 and 2 may for example include a third step (hereinafter may be abbreviated as “Step 2”) which includes separating, from the gas (gaseous phase), the liquid (liquid phase) which was obtained through Step 2 and contains an oligosilane represented by formula (P).

From the liquid containing an oligosilane represented by formula (P), the oligosilane represented by formula (P) will be finally isolated through a refining step and the like to be described later, while in a recycling method, the gas (gaseous phase) will be reused in Step 1-1 or 1-2 after the fourth step and the like to be described later.

Step 3 may for example be carried out using an apparatus employing gravitational separation, an apparatus employing surface tension separation, or an apparatus employing centrifugal separation.

In a recycling method, tetrahydrosilane (SiH₄) dissolved in the liquid phase (liquid containing an oligosilane represented by formula (P)) is preferably heated to vaporize. By heating and vaporizing tetrahydrosilane (SiH₄), condensation in a circulating pump (compressor) or the like is made unlikely to occur.

The heating temperature is generally at least 30° C. and not more than 300° C. and preferably at least 50° C. and not more than 150° C.

(Step 4)

When the production methods 1 and 2 are recycling methods, the production methods 1 and 2 may for example include a fourth step (hereinafter may be abbreviated as “Step 4”) which includes separating hydrogen gas from the gas (gaseous phase) which was obtained through Step 3, using a hydrogen separation membrane.

In a recycling method, hydrogen gas produced as a by-product by a reaction is accumulated. By inclusion of Step 4, hydrogen gas can be appropriately removed.

A hydrogen separation membrane is a semipermeable membrane which selectively allows hydrogen gas to permeate therethrough. The semipermeable membrane for example includes a compact layer which selectively allows hydrogen gas to permeate therethrough and a porous base material which supports the compact layer. Examples of the shape of the semipermeable membrane include a flat membrane, a spiral membrane, and a hollow fiber membrane, among which a hollow fiber membrane is more preferable. Examples of materials used for the compact layer include polyimide, polysiloxane, polysilazane, acrylonitrile, polyester, cellulose polymer, polysulfone, polyalkylene glycol, polyethylene, polybutadiene, polystyrene, polyvinyl halide, polyvinylidene halide, polycarbonate, and a block copolymer having any of these repeating units. Other than those using the above polymeric materials, those using a publicly known material such as carbon materials and palladium having hydrogen permeability may be used.

(Refining Step)

The production methods 1 and 2 may for example include a refining step (hereinafter may be abbreviated as “refining step”) which includes isolating an oligosilane represented by formula (P) from the liquid which was obtained through Step 3 and contains the oligosilane represented by formula (P). The refining step may not only isolate an oligosilane represented by formula (P), but may also isolate tetrahydrosilane (SiH₄), hexahydrodisilane (Si₂H₆), an oligosilane with a larger number of silicon atoms than the oligosilane represented by formula (P), and the like according to the purposes.

The method for isolating an oligosilane represented by formula (P) in the refining step is not particularly limited, and for example, an oligosilane represented by formula (P) is isolated by distillation.

In addition to the above-described Steps 1-1, 1-2, 2, 3, and 4 and the refining step, the production methods 1 and 2 may also include a heating step, a cooling step, a pressurizing step, and a depressurizing step to adjust temperature and pressure for a subsequent step, and a filtering step to separate solids. Particularly in a recycling method, for example, a compressor or the like is used to introduce recovered tetrahydrosilane (SiH₄) and the like into a reactor, and addition of a raw material such as additional tetrahydrosilane (SiH₄) and an oligosilane represented by formula (R-1) or (R-2) is made.

Examples of the specific aspects of the production method 1 as a batch method include an aspect in which Steps 1-1, 2, and 3 and the refining step are included. Step 1-1 for example uses a batch reactor, and Steps 2 and 3, the refining step, and the like for example use dedicated batch apparatuses and dedicated batch tools.

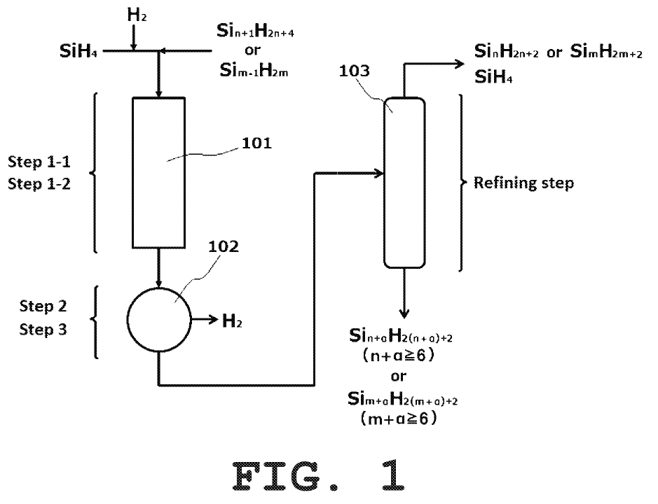

Examples of the production method 1 as a continuous one-pass method include an aspect in which Steps 1-1, 2, and 3 and the refining step are included. In such an aspect, for example, an apparatus as shown in FIG. 1 is used. The configuration of the apparatus in FIG. 1 is described in detail in the following.

First, the raw material gas is pressurized to a predetermined pressure, preheated, and introduced into a reactor 101 set to a predetermined temperature. The gas (mixture) containing a product of a reaction here is sent to a liquid recovery unit 102 which performs a next step in which silanes are collected by a compression cryogenic condensation treatment, an absorbing liquid treatment or an adsorbent treatment. In doing so, the mixture may be sent to the liquid recovery unit 102 through a filter for separating a solid oligosilane(s) in preparation for abnormality. In such a case, for achieving more efficient condensation, it is better to lower the reaction gas temperature with a heat exchanger or the like. When a continuous one-pass reaction is performed, it is better to condense the reaction gas except hydrogen gas as much as possible, including monosilane as a raw material. Thus, when the reaction pressure of a compression cryogenic condenser is set low, it is preferable to apply further pressure to make condensation more easy to occur, and also to set the temperature lower than the condensation temperature of disilane under the operation pressure. The operation pressure is preferably at least 0.11 MPa which is slightly more pressurized than atmospheric pressure, more preferably at least 0.2 MPa, and even more preferably at least 0.3 MPa.

In the case of absorption with an absorption liquid and in the case of treatment with an adsorbent, basically it is better likewise to perform the treatment under a higher pressure and at a lower temperature. In any case, since the temperature is very high immediately after discharged from the reactor, it is advantageous in cost and thus preferable to perform precooling through a plurality of heat exchangers while recovering thermal energy as much as possible.

The liquid condensed here which contains components in the mixture is separated from uncondensed gas which is mainly of hydrogen gas and is subsequently subjected to refining in a distiller 103. Refining in the distiller 103 may be carried out by a batch operation after the liquid is accumulated to some extent or may be carried out by continuous distillation. Since monosilane, disilane, trisilane, tetrasilane, and pentasilane have different boiling points, it is desirable to fractionate targeted silanes by increasing their respective purities through rectification.

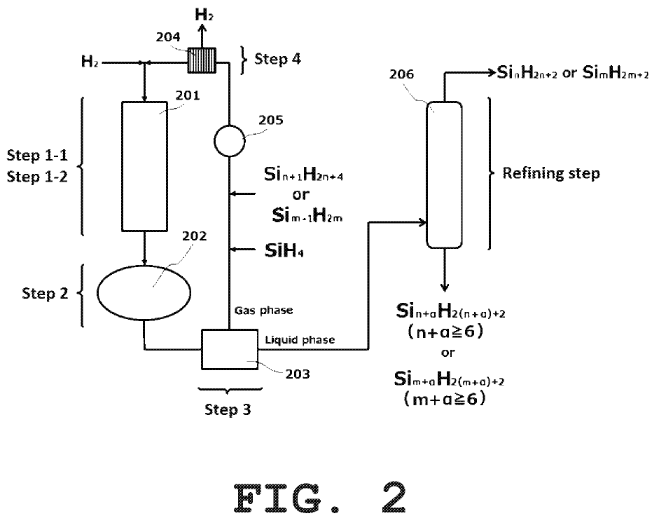

Examples of the production method 1 as a continuous recycling method include an aspect in which Steps 1-1, 2, 3 and 4 and the refining step are included, the gas obtained through Step 4 is used for Step 1-1, and further the liquid which was obtained through Step 3 and contains an oligosilane(s) is subjected to the refining step. In such an aspect, for example, an apparatus as shown in FIG. 2 is used. The configuration of the apparatus in FIG. 2 is described in detail in the following.

First, recycled gas and newly introduced raw material gas are mixed to be a predetermined mixing ratio, then pressurized and preheated as needed, and subsequently introduced into a reactor 201 which is set to a predetermined temperature. With respect to the gas (mixture) discharged from the reactor and containing a product, in the same manner as in a one-pass method, a filter for separation from a solid oligosilane(s) may be provided for responding to abnormality, and thermal energy may be recovered from the reaction gas with a heat exchanger, which also serves as precooling. The gas (mixture) which contains the product and has been precooled as needed is sent to a liquid recovery unit 202 which performs a step in which the produced oligosilanes are collected by a compression cryogenic condensation treatment, an absorbing liquid treatment or an adsorbent treatment. Here, when recycling, since it is desirable to condense produced oligosilanes only without condensing raw material monosilane, a lower operation pressure and a higher cooling temperature than those in a one-pass method are set.

However, since monosilane gas dissolves into oligosilanes to some extent, a condensate (liquid) condensed in the liquid recovery unit 202 by various methods is sent to an evaporator 203 which separates gas and liquid. Here, since it is better to vaporize dissolved monosilane as much as possible, the operation pressure is decreased to vaporize dissolved monosilane, and vaporized monosilane is sent to the reactor together with uncondensed gas, including hydrogen gas. When it is intended to increase recovery of monosilane gas, disilane and trisilane are entrained and also vaporized. Thus, the actual operation conditions need to be determined taking into consideration an allowable loss rate of monosilane and an entrainment rate of oligosilanes such as disilane and trisilane. In this way, the concentration of each of monosilane, disilane, and trisilane in the recycled gas is analyzed, and raw material gas not sufficient for causing the reaction is added. Since disilane and trisilane are used as raw materials, if the condensation-evaporator operation is carried out well, the amount of further addition can be reduced, or the adding operation can be omitted. After mixed with raw material gas, the recycled gas is pressurized using a compressor 205 as needed and sent to a hydrogen separating membrane 204. Depending on the concentration of silanes, it is preferable to perform preheating to prevent condensation during pressurization.

Although raw material gas is mixed prior to the hydrogen separating membrane in the illustration in FIG. 2, the raw material gas may be added after the separation.

When hydrogen gas is introduced into the reactor, it is better to adjust the separation conditions at the separation membrane such that only hydrogen gas produced as a by-product is separated to thereby secure a desired hydrogen gas partial pressure. However, if the concentration of hydrogen gas is not enough, hydrogen gas is added.

The reaction gas having a thus adjusted raw material gas concentration is pressurized and has its temperature increased as necessary before being sent to the reactor 201.

On the other hand, the condensate (liquid) separated at the evaporator 203 is sent to a distiller 206 for refining oligosilanes. The distiller 206 is the same as the distiller 103 in a one-pass method, and refining may be carried out by batch distillation if a temporary storage tank for a product is available, or may be carried out by continuous distillation.

Examples of the specific aspects of the production method 2 as a batch method include an aspect in which Steps 1-2, 2, and 3 and the refining step are included. Step 1-2 for example uses a batch reactor, and Steps 2 and 3, the refining step, and the like for example use dedicated batch apparatuses and dedicated batch tools.

Examples of the production method 2 as a continuous one-pass method include an aspect in which Steps 1-2, 2, and 3 and the refining step are included. In such an aspect, for example, the above-described apparatus as shown in FIG. 1 is used.

Examples of the production method 2 as a continuous recycling method include an aspect in which Steps 1-2, 2, 3 and 4 and the refining step are included, the gas obtained through Step 4 is used for Step 1-2, and further the liquid which was obtained through Step 3 and contains an oligosilane is subjected to the refining step. In such an aspect, for example, the above-described apparatus as shown in FIG. 2 is used.

### EXAMPLES

The present invention is described in additional detail using the examples and comparative examples provided below, but modifications can be made as appropriate insofar as there is no departure from the essential features of the present invention.

### Preparative Example 1: Preparation of Zeolite

NH₄-ZSM-5 (silica/alumina ratio=23, Tosoh Corporation, product name: HSZ-800 type 820NHA) in an amount of 20 g was dried for 2 hours at 110° C. followed by firing for 2 hours at 700° C. to provide H-ZSM-5 in powder form which does not contain any transition element.

### Preparative Example 2: Preparation of Molybdenum(Mo)-Loaded Zeolite

Distilled water in an amount of 20 g and 0.37 g of (NH₄)₆Mo₇O₂₄.4H₂O (corresponding to a loading of 1 mass % as Mo) were added to 20 g of NH₄—ZSM-5 (silica/alumina ratio=23, Tosoh Corporation, product name: HSZ-800 type 820NHA), and mixing was carried out for 1 hour at room temperature. Subsequently, the mixture was dried for 2 hours at 110° C. and then fired for 2 hours at 700° C. to provide 1 mass % Mo-loaded ZSM-5 in powder form.

### Preparative Example 3: Preparation of Cobalt(Co)-Loaded Zeolite

Distilled water in an amount of 20 g and 0.99 g of Co(NO₃).6H₂O (corresponding to a loading of 1 mass % as Co) were added to 20 g of NH₄—ZSM-5 (silica/alumina ratio=23, Tosoh Corporation, product name: HSZ-800 type 820NHA), and mixing was carried out for 1 hour at room temperature. Subsequently, the mixture was dried for 2 hours at 110° C. and then fired for 2 hours at 700° C. to provide 1 mass % Co-loaded ZSM-5 in powder form.

### Examples 1 and 2, Comparative Example 1

H-ZSM-5 prepared in Preparative Example 1 and in an amount of 1.0 g was placed in a reaction tube (made of stainless steel, outer diameter: 19.05 mm, thickness: 1.24 mm, length: 230 mm). The air was removed from the reaction tube using a vacuum pump, and substitution with helium gas was then carried out. The helium gas was caused to flow through at a rate of 20 mL/minute and the temperature was raised to 200° C., after which throughflow was performed for 1 hour. Subsequently, each mixed gas was adjusted to provide the reaction gas composition described in Table 1, and caused to flow through at a rate of 10 mL/minute. As shown in Table 1, after the elapse of 4 hours, the composition of the reaction gas was analyzed by gas chromatography (GC-17A from Shimadzu Corporation, detector: a TCD, analysis column: TC-BOND Q from GL Sciences Inc.), and the conversion of monosilane, the yields of disilane and trisilane, and the space-time yields (STY) of disilane and trisilane were calculated. The results are given in Table 1.

In calculating the yields of disilane and trisilane, only monosilane supplied as a raw material was based on, and the following formulae were used for calculation.

Disilane yield=(produced disilane [mol]−raw material disilane [mol])×2/raw material monosilane [mol]

Trisilane yield=(produced trisilane [mol]−raw material trisilane [mol])×3/raw material monosilane [mol]

Disilane STY [g/kg·h]=(produced disilane per hour [g/h])/(catalyst amount [kg])

Trisilane STY [g/kgh]=(produced trisilane per hour [g/h])/(catalyst amount [kg])

TABLE 1

| | Reaction | | Supplied gas composition | | | | | | Silane | Disilane | Trisilane | Residence | STY | |
|---|---|---|---|---|---|---|---|---|---|---|---|---|---|---|
| | Temperature | Time | (mol %) | | | | | | Conversion | Yield | Yield | Time | (g/kgh) | |
| | (° C.) | (h) | Silane | Disilane | Trisilane | Ar | He | H₂ | (%) | (%) | (%) | (second) | Disilane | Trisilane |
| Comparative | 200 | 4 | 8 | 0 | 0 | 2 | 80 | 10 | 3.1 | 1.2 | 0.3 | 17 | 0.8 | 0.2 |
| Example 1 | | | | | | | | | | | | | | |
| Example 1 | 200 | 4 | 7.98 | 0 | 0.02 | 2 | 80 | 10 | 2.3 | 1.5 | 0.0 | 17 | 0.9 | 0.0 |
| Example 2 | 200 | 4 | 7.9 | 0.1 | 0 | 2 | 80 | 10 | 1.3 | −0.1 | 1.5 | 17 | −0.1 | 0.9 |

### Examples 3 and 4, Comparative Example 2

Operation and analysis were carried out in the same manner as in Examples 1 and 2 and Comparative Example 1, except that in lieu of H-ZSM-5 prepared in Preparative Example 1, 1 mass % Mo-loaded ZSM-5 prepared in Preparative Example 2 was used. The results are given in Table 2.

TABLE 2

| | Reaction | | Suppled gas composition | | | | | | Silane | Disilane | Trisilane | Residence | STY | |
|---|---|---|---|---|---|---|---|---|---|---|---|---|---|---|
| | Temperature | Time | (mol %) | | | | | | Conversion | Yield | Yield | Time | (g/kgh) | |
| | (° C.) | (h) | Silane | Disilane | Trisilane | Ar | He | H₂ | (%) | (%) | (%) | (second) | Disilane | Trisilane |
| Comparative | 200 | 4 | 8 | 0 | 0 | 2 | 80 | 10 | 12.4 | 5.3 | 1.5 | 17 | 3.4 | 1.0 |
| Example 2 | | | | | | | | | | | | | | |
| Example 3 | 200 | 4 | 7.88 | 0 | 0.12 | 2 | 80 | 10 | 11.2 | 6.8 | 0.0 | 17 | 4.4 | 0.0 |
| Example 4 | 200 | 4 | 7.58 | 0.42 | 0 | 2 | 80 | 10 | 7.7 | 0.1 | 6.8 | 17 | 0.1 | 4.3 |

### Examples 5 and 6, Comparative Example 3

Operation and analysis were carried out in the same manner as in Examples 1 and 2 and Comparative Example 1, except that in lieu of H-ZSM-5 prepared in Preparative Example 1, 1.0 g of 1 mass % Co-loaded ZSM-5 prepared in Preparative Example 3 was used. The results are given in Table 3.

TABLE 3

| | Reaction | | Supplied gas composition | | | | | | Silane | Disilane | Trisilane | Residence | STY | |
|---|---|---|---|---|---|---|---|---|---|---|---|---|---|---|
| | Temperature | Time | (mol %) | | | | | | Conversion | Yield | Yield | Time | (g/kgh) | |
| | (° C.) | (h) | Silane | Disilane | Trisilane | Ar | He | H₂ | (%) | (%) | (%) | (second) | Disilane | Trisilane |
| Comparative | 200 | 4 | 8 | 0 | 0 | 2 | 80 | 10 | 9.3 | 4.9 | 1.1 | 17 | 3.1 | 0.7 |
| Example 3 | | | | | | | | | | | | | | |
| Example 5 | 200 | 4 | 7.91 | 0 | 0.09 | 2 | 80 | 10 | 8.2 | 6.0 | 0.1 | 17 | 3.9 | 0.1 |
| Example 6 | 200 | 4 | 7.61 | 0.39 | 0 | 2 | 80 | 10 | 4.6 | 0.0 | 6.0 | 17 | 0.0 | 3.9 |

When compared with the corresponding comparative examples, Examples 1, 3 and 5, in which trisilane was fed, demonstrate almost no difference between the amount of trisilane present in the supplied gas and that in the outlet gas composition, while demonstrating improvements in the disilane yields.

Examples 2, 4 and 6, in which disilane was fed, demonstrate almost no difference between the amount of disilane supplied and the amount of disilane in the outlet gas (the apparent yield is almost 0%), while demonstrating improvements in the trisilane yields.

<Experiments on One-Pass Method and Recycling Method>

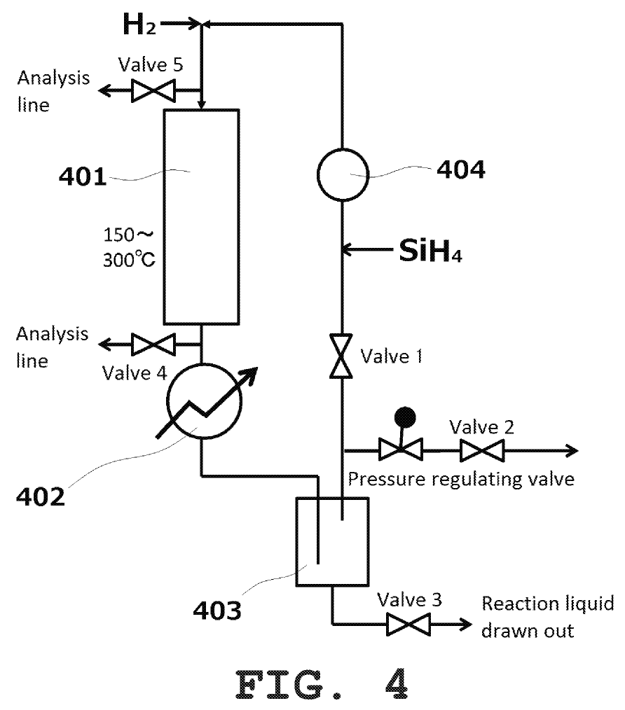

An experimental recycling apparatus shown in FIG. 4 was used to carry out circulation experiments on the reaction gas.

A reactor 401 was filled with 500 g of 1% Co-loaded ZSM-5 prepared in Preparative Example 3. The air was removed from a reaction tube using a vacuum pump (not shown), and substitution with nitrogen gas was then carried out. With valves 1, 3, 4, and 5 closed and a valve 2 opened, while nitrogen gas was caused to flow through at a rate of 100 mL/minute from a nitrogen introduction line (not shown) located at the same position as (beside) the hydrogen gas introduction line, the temperature of a catalyst layer was raised to 400° C., after which throughflow was performed for 1 day.

Subsequently, the temperature of the catalyst layer was decreased to 150° C. In order to use hydrogen gas as a diluent gas in a reaction, the pressure in the reactor system was increased to reach 0.15 MPa (gauge pressure) using hydrogen gas via a hydrogen gas flow meter under control with a pressure regulating valve, and a flow rate of 6.5 L/minutes was maintained for 1 hour. Further, the pressure in the reactor system was increased to reach 0.2 MPa (gauge pressure) using monosilane at a flow rate of 0.01 L/minute from a monosilane container via a monosilane flow meter under control with a pressure regulating valve, and this state was maintained for 47 hours.

(In One-Pass Method)

Subsequently, with the valve 1 kept closed and the valve 2 kept opened, cooling water at a temperature of 5° C. was caused to flow through a heat exchanger 402, a cold trap 403 was cooled to −80° C., and a reaction was run for 2 hours at a hydrogen gas flow rate of 6.5 L/minute and a monosilane flow rate of 3.5 L/minute. In this case, the inlet gas concentration was 35 mol % monosilane and 65 mol % hydrogen gas, and analysis of reactor outlet gas discharged via the valve 4 showed 31.7 mol % monosilane, 1.13 mol % disilane, and 0.227 mol % trisilane. When calculated from the above, the monosilane conversion was 9.4%, the disilane yield was 6.5%, and the trisilane yield was 1.9/%.

(In Recycling Method)

Next, with the valve 2 kept opened and the control pressure of the pressure regulating valve kept at 0.2 MPa, the valve 1 was opened to allow for circulation of monosilane and oligosilanes which had not been trapped at the cool trap. At the same time, while inlet gas introduced was analyzed via the valve 5, monosilane was added as raw material gas for the amount consumed in the above-described reaction and not sufficed by the monosilane contained in the circulating (recycled) gas, and the hydrogen gas flow rate, the monosilane flow rate, and the disilane flow rate were controlled in such a manner to achieve the inlet gas concentration described in Table 4. Disilane used as the raw material gas was obtained by distilling a reaction liquid drawn out via the valve 3.

TABLE 4

| | Monosilane | Disilane |
|---|---|---|
| Inlet gas concentration | 35.0 mol % | 0.20 mol % |

Under the above cooling conditions, no trisilane was detected.

The composition of the outlet gas drawn out via the valve 4 when the reaction was run for 2 hours under the above conditions was analyzed. The result was as described in Table 5.

TABLE 5

| | Monosilane | Disilane | Trisilane |
|---|---|---|---|
| Outlet gas composition | 32.1 mol % | 1.21 mol % | 0.312 mol % |

When calculated from the result, the monosilane conversion was 8.2%, the disilane yield was 5.8%, and the trisilane yield was 2.7%, which demonstrates that feeding of disilane caused an improvement in the trisilane yield.

Next, while the inlet gas introduced was analyzed via the valve 5, to the recycled gas containing monosilane and oligosilanes which had not been trapped at the cool trap, trisilane was added as raw material gas together with monosilane for the amount consumed in the above-described reaction and not sufficed by the monosilane contained in the recycled gas, and the hydrogen gas flow rate, the monosilane flow rate, and the trisilane flow rate were controlled in such a manner to achieve the inlet gas concentration described in Table 6. Trisilane used as the raw material gas was obtained by distilling a reaction liquid drawn out via the valve 3.

TABLE 6

| | Monosilane | Disilane | Trisilane |
|---|---|---|---|
| Inlet gas concentration | 35.0 mol % | 0.20 mol % | 0.50 mol % |

The composition of the outlet gas drawn out via the valve 4 when the reaction was run for 2 hours under the above conditions was analyzed. The result was as described in Table 7.

TABLE 7

| | Monosilane | Disilane | Trisilane |
|---|---|---|---|
| Outlet gas composition | 32.6 mol % | 1.23 mol % | 0.32 mol % |

When calculated from the result, the monosilane conversion was 6.9%, the trisilane conversion was 36.0%, and the disilane yield was 5.9%, and trisilane conversely had a lower concentration in the outlet gas. This demonstrates that feeding of trisilane causes decomposition of trisilane, contributing to production of disilane.

For reference purposes, the disilane yield was calculated as 5.6% by the following formula which takes into account feeding of trisilane as the raw material.

Disilane yield=(produced disilane [mol]−raw material disilane [mol])×2/(raw material monosilane [mol]+raw material trisilane [mol]×3)

### INDUSTRIAL APPLICABILITY

According to the oligosilane production method according to one aspect of the present invention, oligosilanes can be efficiently produced at an improved selectivity for a target oligosilane. The disilane provided by the oligosilane production method according to one aspect of the present invention can be used as a gas for the production of silicon for semiconductors and is expected to provide improved productivity in the semiconductor industry due to the improved disilane yield and selectivity.

### REFERENCE SIGNS LIST

101 Reactor
102 Liquid recovery unit (compression cryogenic condensation, absorbing liquid or adsorbent)
103 Distiller
201 Reactor
202 Liquid recovery unit (compression cryogenic condensation, absorbing liquid or adsorbent)
203 Evaporator (liquid-gas separation)
204 Hydrogen separating membrane
205 Compressor
206 Distiller
401 Reactor
402 Heat exchanger
403 Cold trap
404 Compressor

1. A method for producing an oligosilane, comprising a step 1-1 of producing an oligosilane represented by the following formula (P-1) using tetrahydrosilane (SiH₄) as a raw material:
SiₙH₂ₙ₊₂ (P-1)
where n represents an integer of from 2 to 5,
the step 1-1 comprising producing the oligosilane represented by formula (P-1) from an oligosilane represented by the following formula (R-1) using the oligosilane represented by formula (R-1) as a raw material together with tetrahydrosilane (SiH₄): 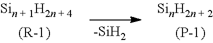
where n represents an integer of from 2 to 5.

2. The method for producing an oligosilane according to claim 1, wherein
the oligosilane represented by formula (R-1) is octahydrotrisilane (Si₃H₈), and the oligosilane represented by formula (P-1) is hexahydrodisilane (Si₂H₆).

3. A method for producing an oligosilane, comprising a step 1-2 of producing an oligosilane represented by the following formula (P-2) using tetrahydrosilane (SiH₄) as a raw material:
SiₘH₂ₘ₊₂ (P-2)
where m represents an integer of from 3 to 5,
the step 1-2 comprising producing the oligosilane represented by formula (P-2) from an oligosilane represented by the following formula (R-2) using the oligosilane represented by formula (R-2) as a raw material together with tetrahydrosilane (SiH₄): 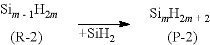
where m represents an integer of from 3 to 5.

4. The method for producing an oligosilane according to claim 3, wherein
the oligosilane represented by formula (R-2) is hexahydrodisilane (Si₂H₆), and the oligosilane represented by formula (P-2) is octahydrotrisilane (Si₃H₈).

5. The method for producing an oligosilane according to claim 1, wherein
the step 1-1 or 1-2 is carried out in the presence of hydrogen gas.

6. The method for producing an oligosilane according to claim 1, wherein
the step 1-1 or 1-2 is carried out in the presence of a catalyst containing a transition element.

7. The method for producing an oligosilane according to claim 6, wherein
the transition element contained in the catalyst is at least one transition element selected from the group consisting of group 5 transition elements, group 6 transition elements, group 7 transition elements, group 8 transition elements, group 9 transition elements, and group 10 transition elements.

8. The method for producing an oligosilane according to claim 6, wherein
the catalyst is a heterogeneous catalyst containing a support.

9. The method for producing an oligosilane according to claim 8, wherein
the support is at least one selected from the group consisting of silica, alumina, and zeolites.

10. The method for producing an oligosilane according to claim 9, wherein
the zeolite has pores with a minor diameter of at least 0.43 nm and a major diameter of not more than 0.69 nm.

11. The method for producing an oligosilane according to claim 1, further comprising a second step comprising subjecting a mixture obtained through the step 1-1 or 1-2 to at least one treatment selected from the following treatments (i) to (iii) to obtain a liquid containing the oligosilane represented by formula (P-1) or (P-2):
(i) compressing and/or cooling the mixture;
(ii) bringing the mixture in contact with an absorbing liquid; and
(iii) bringing the mixture in contact with an adsorbent, followed by desorbing and compressing and/or cooling.

12. The method for producing an oligosilane according to claim 11, wherein
in the treatment (i), a cooling temperature is from −200° C. to −20° C.

13. The method for producing an oligosilane according to claim 11, wherein
in the treatment (ii), the absorbing liquid is at least one liquid selected from the group consisting of hydrogenated silicon compounds, saturated hydrocarbons, and aromatic hydrocarbons.

14. The method for producing an oligosilane according to claim 11, wherein
in the treatment (iii), the adsorbent is at least one solid adsorbent selected from the group consisting of natural zeolites, synthetic zeolites, alumina gel, silica gel, and activated carbon.

15. The method for producing an oligosilane according to claim 11, further comprising a third step comprising separating the liquid obtained through the second step and containing the oligosilane represented by formula (P-1) or (P-2) from gas being a gaseous phase.

16. The method for producing an oligosilane according to claim 15, further comprising a fourth step comprising separating hydrogen gas from the gas being a gaseous phase obtained through the third step using a hydrogen separating membrane.

17. The method for producing an oligosilane according to claim 1, wherein
the method is a one-pass method where the step 1-1 or 1-2 is carried out only once.

18. The method for producing an oligosilane according to claim 16, wherein
the method is a recycling method where at least part of tetrahydrosilane (SiH₄) and the oligosilane represented by formula (R-1) unreacted in the step 1-1 is resupplied and reused as a raw material.

19. The method for producing an oligosilane according to claim 16, wherein
the method is a recycling method where at least part of tetrahydrosilane (SiH₄) and the oligosilane represented by formula (R-2) unreacted in the step 1-2 is resupplied and reused as a raw material.
